(19) United States
(12) Patent Application Publication
(10) Pub. No.: US 2010/0278325 A1
(43) Pub. Date: Nov. 4, 2010

(54) Annoying Telephone-Call Prediction and Prevention

(75) Inventors: Navjot Singh, Denville, NJ (US); Saurabh Bagchi, West Lafayette, IN (US); Yu-Sung Wu, West Lafayette, IN (US)

Correspondence Address: Avaya;DEMONT & BREYER, LLC, 100 COMMONS WAY, STE 250, HOLMDEL, NJ, 07733, US

(73) Assignees: AVAYA INC., Basking Ridge, NJ (US); PURDUE RESEARCH FOUNDATION, West Lafayette, IN (US)

(21) Appl. No.: 12/434,750

(22) Filed: May 4, 2009

(51) Int. Cl. H04M 3/42

(52) U.S. Cl. 379/210.02

(57) ABSTRACT

A method for predicting whether a telephone call that is being set up will be considered annoying by the called party and, if so, for preventing it from being established. The illustrative embodiment predicts whether a telephone call will be considered annoying by the called party based on temporal characteristics of previous calls from the same caller. For example, when a called party receives an unwanted telephone solicitation, he or she will usually hang up within the first minute. If many telephone calls are made from the same caller, and all of these calls last under a minute, then it is reasonable to predict that future calls from this caller will be considered annoying.

### FIELD OF THE INVENTION

The present invention relates to telecommunications in general, and, more particularly, to the prevention of annoying telephone calls.

### BACKGROUND OF THE INVENTION

The invention of the telephone has been a mixed blessing. The telephone is a blessing when a friend calls and a curse when a telemarketer calls. The invention of Voice-over-Internet-Protocol (“VoIP”) telephony enables a telemarketer to place a telephone call for less money than was possible in the past, and, therefore, telemarketers will probably inundate people in the future with annoying telephone calls in the same way that spammers inundate people with annoying e-mail.

Therefore, the need exists for a mechanism that prevents people from being inundated with annoying telephone calls.

### SUMMARY OF THE INVENTION

The present invention provides a mechanism for predicting whether a telephone call that is being set up will be considered annoying by the called party and, if so, for preventing it from being established. Predicting whether a telephone call will be considered annoying is, in some respects, analogous to predicting whether an e-mail will be considered annoying, and, therefore, some of the techniques for predicting whether an e-mail will be considered annoying can be used to predict whether a telephone call will be considered annoying. For example, when twenty annoying e-mails arrive from one sender, it is reasonable to predict that the twenty-first e-mail from that sender will also be annoying and should be blocked. Analogously, when twenty annoying telephone calls arrive from one caller, it is reasonable to predict that the twenty-first telephone call from that caller will also be annoying.

A telephone call is not analogous to an e-mail all respects, and, therefore, predicting whether a telephone call will be considered annoying is not the same as predicting whether an e-mail will be considered annoying. For example, when predicting whether an e-mail will be considered annoying or not, the contents of the e-mail can be examined, but when predicting whether a telephone call that has not yet occurred will be considered annoying or not, the contents of the call cannot be examined. Furthermore, each telephone call is by its very nature interactive, which an e-mail is not, and, therefore, its content is not determined solely by the caller, but by the called party as well. It is for these reasons that predicting whether a telephone call will be considered annoying is not fully analogous to predicting whether an e-mails will be considered annoying.

The illustrative embodiment predicts whether a telephone call will be considered annoying by the called party based on temporal characteristics of previous calls from the same caller. For example, when a called party receives an unwanted telephone solicitation, he or she will usually hang up within the first minute. If many telephone calls are made from the same caller, and all of these calls last under a minute, then it is reasonable to predict that future calls from this caller will be considered annoying.

As another example, when many calls are made from the same caller immediately one after another, it is reasonable to assume that the caller is using an auto-dialer or working off of a call list. In this case, it is reasonable to predict that future calls from this caller will be considered annoying.

As yet another example, when many calls are made from the same caller within a given time interval, it is reasonable to assume that the caller is using an auto-dialer or working off of a call list. In this case, it is reasonable to predict that future calls from this caller will be considered annoying.

In yet another example, when many calls from the same caller are characterized by the caller speaking for most of the telephone call, it is reasonable to predict that future calls from this caller will be considered annoying.

The illustrative embodiment comprises: receiving a request to establish a telephone call from a caller; and transmitting one of: an indication that the telephone call will be established as requested, and an indication that the telephone call will not be established as requested, based on an indicium of a temporal characteristic of a previous telephone call from the caller.

### BRIEF DESCRIPTION OF THE DRAWINGS

FIG. 1 depicts a schematic diagram of the salient components of telecommunications system 100 in accordance with the illustrative embodiment of the present invention.

FIG. 2 depicts a flowchart of the salient tasks associated with the operation of the illustrative embodiment of the present invention.

### DETAILED DESCRIPTION

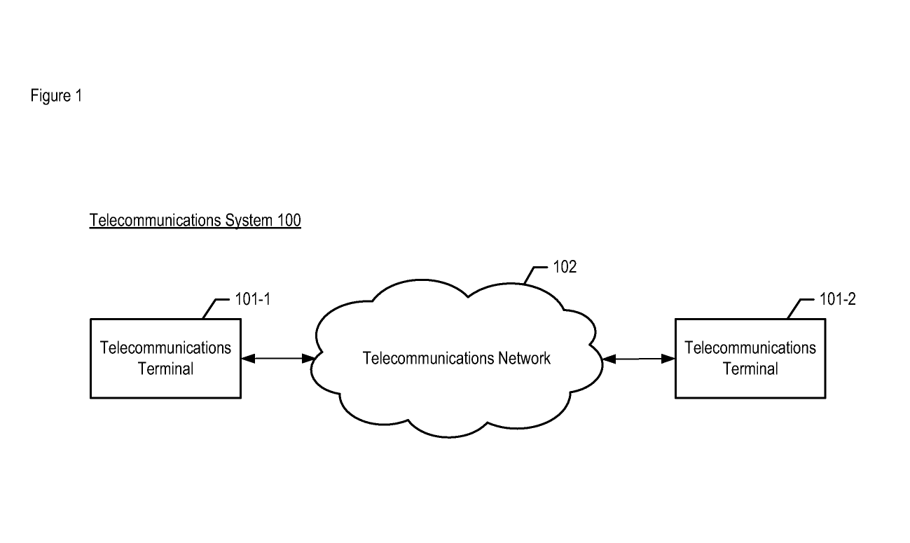

FIG. 1 depicts a schematic diagram of the salient components of telecommunications system 100 in accordance with the illustrative embodiment of the present invention. Telecommunications system 100 comprises: telecommunications terminal 101-1, telecommunications network 102, and telecommunications terminal 101-2, interconnected as shown. Although the illustrative embodiment comprises two telecommunications terminals, it will be clear to those skilled in the art, after reading this disclosure, how to make and use alternative embodiments of the present invention that comprise any number of telecommunications terminals.

Telecommunications terminals 101-1 and 101-2 are each hardware and software that enable users to place and receive telephone calls through telecommunications network 102, and it will be clear to those skilled in the art how to make and use telecommunications terminals 101-1 and 101-2. For the purposes of this disclosure, a “telephone call” is defined as an interactive telecommunication session involving two or more telecommunications terminals, and, therefore, includes, but is not limited to telecommunications terminals capable of handling:
i. audio,
ii. text, or
iii. still images, or
iv. moving images, or
v. any combination of i, ii, iii, and iv.

Telecommunications network 102 is the Public Switched Telephone Network, but it will be clear to those skilled in the art, after reading this disclosure, how to make and use alternative embodiments of the present invention in which telecommunication network 102 is another network, such as, for example and without limitation, the Internet, a private data network, a satellite network.

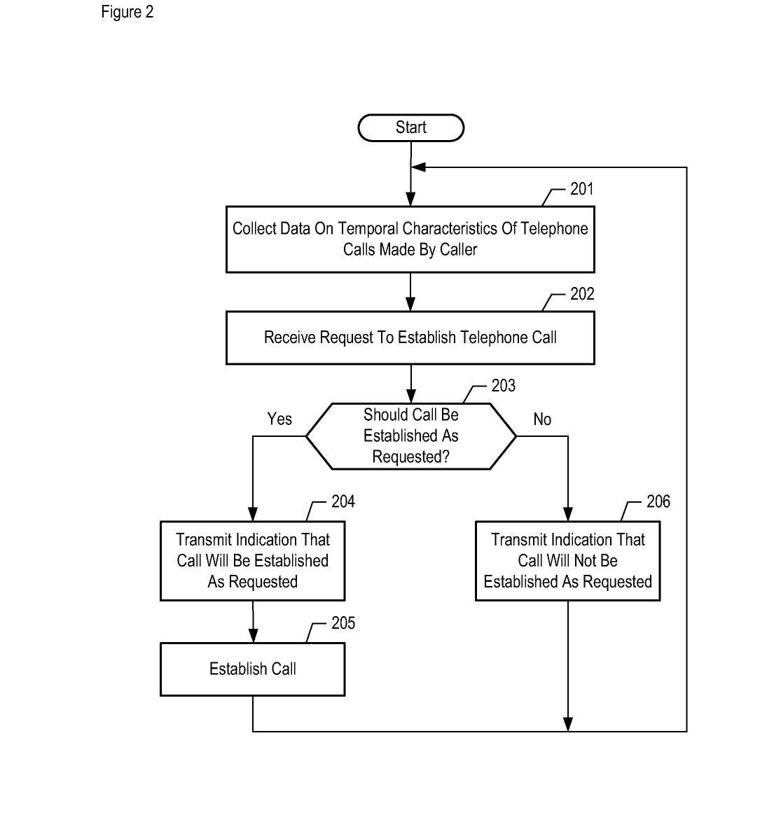

FIG. 2 depicts a flowchart of the salient tasks associated with the operation of the illustrative embodiment of the present invention.

At task 201, telecommunications network 102 monitors all telephone calls from telecommunications terminal 101-1 and generates indicia of the temporal characteristics of those calls. For example, telecommunications network 102 collects for each call:
i. the time when each call began, and
ii. the time when each call ended, and
iii. the amount of time during each call when the caller spoke, and
iv. the amount of time during each call when the called-party spoke, and
v. feedback from the called-party indicating whether the call was unsolicited and undesirable.
   From this, the temporal characteristics of those calls are generated. The temporal characteristics include, but are not limited to:
i. the duration of each call, and
ii. the total duration of all calls that conform to a criterion (e.g., the call is answered by a human being, etc.), and
iii. a histogram of the duration of all calls that conform to a criterion,
iv. the mean, median, and standard deviation of duration of all of the calls that conform to a criterion, and
v. the time intervals between each pair of successive calls, and
vi. the total time intervals between each pair of successive calls that conform to a criterion, and
vii. a histogram of the time intervals between each pair of successive calls that conform to a criterion, and
viii. the mean, median, and standard deviation of the time intervals between each pair of successive calls that conform to a criterion, and
ix. the radio of time in which the caller speaks divided by the time in which the called-party speaks for each call that conforms to a criterion, and
x. a histogram of the ratio of time in which the caller speaks divided by the time in which the called-party speaks for each call that conforms to a criterion, and
xi. the mean, median, and standard deviation of the ratio of time in which the caller speaks divided by the time in which the called-party speaks for each call that conforms to a criterion, and
xii. the number of calls that conform to a criterion, and
xiii. the average number of calls that conform to a criterion.

At task 202, telecommunications network 102 receives a request from terminal 101-1 to establish a telephone call with telecommunications terminal 101-2. As part of task 202, telecommunications network 102 generates an indicium of the time interval between the termination of the previous telephone call from the caller and the receipt of the request.

At task 203, telecommunications network 102 determines whether a telephone call should be established or blocked based on the likelihood that the call will be considered annoying by the called party at telecommunications terminal 101-2. The likelihood that the call will be considered undesirable by the called party is based on:
i. a weighted function the temporal characteristics generated in task 201, and
ii. the indicium of the time interval between the termination of the previous telephone call from the caller and the receipt of the request generated in task 202.
   The weight of each temporal characteristic is the correlation of that temporal characteristic to the feedback for the calls used to generate the temporal characteristic. It will be clear to those skilled in the art, after reading this disclosure, how to generate the weights using, for example and without limitation, standard econometric analysis and regression techniques. It will be clear to those skilled in the art, after reading this disclosure, how to make and use alternative embodiments of the present invention which use a neural network to accomplish task 203.

When telecommunications network 102 determines that the requested call should be established, control passes to task 204; otherwise control passes to task 205.

At task 204, telecommunications network 102 transmits to telecommunications terminal 101-1 an indication that the telephone call to telecommunications terminal 101-2 will be established. It will be clear to those skilled in the art, after reading this disclosure, how to make and use alternative embodiments of the present invention in which the indication that the telephone call to telecommunications terminal 101-2 will be established is transmitted to another party.

At task 205, telecommunications network 102 establishes the call between terminal 101-1 and terminal 101-2. From task 205, control passes to task 201 in which data is collected on this call, including whether the called-party considered the call annoying or not.

At task 206, telecommunications network 102 transmits an indication to telecommunications terminal 101-1 that the telephone call to telecommunications terminal 101-2 will not be established, in well-known fashion. It will be clear to those skilled in the art, after reading this disclosure, how to make and use alternative embodiments of the present invention in which the indication that the telephone call to telecommunications terminal 101-2 will be established is transmitted to another party.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving a request to establish a telephone call from a caller; and
transmitting one of:
(i) an indication that the telephone call will be established as requested, and
(ii) an indication that the telephone call will not be established as requested, based on an indicium of a temporal characteristic of a previous telephone call from the caller.

2. The method of claim 1 wherein the indicium of the temporal characteristic is based on the duration of the previous telephone call.

3. The method of claim 1 wherein the indicium of the temporal characteristic is based on the time interval between the termination of the previous telephone call and the initiation of the request.

4. The method of claim 1 wherein the indicium of the temporal characteristic is based on the ratio of time in which the caller of the previous telephone call spoke divided by the time in which the called-party spoke.

5. The method of claim 1 wherein the indicium of the temporal characteristic is based on the number of telephone calls initiated by the caller in a time interval.

6. A method comprising:
receiving a request to establish a telephone call from a caller; and
transmitting one of:
(i) an indication that the telephone call will be established as requested, and
(ii) an indication that the telephone call will not be established as requested, based on an indicium of the duration of a previous telephone call initiated by the caller.

7. The method of claim 6 wherein the transmission of one of the rejection and the approval is also based on an indicium of the time interval between the termination of the previous telephone call and the initiation of the request.

8. The method of claim 6 wherein the transmission of one of the rejection and the approval is also based on an indicium of the ratio of time in which the caller of the previous telephone call spoke divided by the time in which the called-party spoke.

9. The method of claim 6 wherein the transmission of one of the rejection and the approval is also based on the number of telephone calls initiated by the caller in a time interval.

10. A method comprising:
receiving a request to establish a telephone call from a caller; and
transmitting one of:
(i) an indication that the telephone call will be established as requested, and
(ii) an indication that the telephone call will not be established as requested, based on an indicium of the time interval between the termination of a previous telephone call from the caller and the initiation of the request.

11. The method of claim 10 wherein the transmission of one of the rejection and the approval is also based on an indicium of the ratio of time in which the caller of the previous telephone call spoke divided by the time in which the called-party spoke.

12. The method of claim 10 wherein the transmission of one of the rejection and the approval is also based on the number of telephone calls initiated by the caller in a time interval.

13. A method comprising:
receiving a request to establish a telephone call from a caller; and
transmitting one of:
(i) an indication that the telephone call will be established as requested, and
(ii) an indication that the telephone call will not be established as requested, based on an indicium of the number of telephone calls initiated by the caller in a time interval.

14. The method of claim 13 wherein the transmission of one of the rejection and the approval is also based on the indicium of the ratio of time in which the caller of the previous telephone call spoke divided by the time in which the called-party spoke.
